(19) United States
(12) Patent Application Publication
(10) Pub. No.: US 2005/0052119 A1
(43) Pub. Date: Mar. 10, 2005

(54) Organic electronic device having low background luminescence

(76) Inventors: Gang Yu, Santa Barbara, CA (US); Runguang Sun, Shanghai (CN); Jian Wang, Goleta, CA (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 10/658,236

(22) Filed: Sep. 8, 2003

(51) Int. Cl. H05B 33/26; H05B 33/00

(52) U.S. Cl. 313/503; 313/504; 313/506

(57) ABSTRACT

An organic electronic device has an improved contrast ratio by lowering background luminescence from ambient radiation source(s). Background luminescence may be lowered by increasing absorption of ambient radiation, by reducing reflection of ambient radiation, or a combination of the two. Lower background luminescence can be achieved by using one or more black layers or lattices that are incorporated within the organic electronic device. Also, a large number of materials can be used for high absorbance layers. A change in materials for the electronic device may not be needed, and therefore, new material compatibility issues may not arise. Further, from an electronic performance standpoint, some layers may not be too sensitive to thickness and a plurality of narrow ranges of thicknesses may be used for a layer to allow a layer to have the proper electrical and optical properties. The embodiments obviate the need for a circular polarizer.

### FIELD OF THE INVENTION

This invention relates in general to organic electronic devices, and more particularly, to an array of organic electronic devices having low background luminescence (L_{background}).

### DESCRIPTION OF THE RELATED ART

Organic (small molecule or polymer) electroluminescent devices or light-emitting diodes (OLEDs) are promising technologies for flat panel display applications. OLEDs typically include a plurality of electronic device layers including electrode layers, an organic active layer, and may include an optional hole-transport layer, an electron-transport layer, or both. However, the organic electronic devices are not without problems. In OLEDs, the electrode that acts as a cathode is usually made of low work function metals, such as Mg—Ag alloy, Al—Li alloy, Ca/Al, Ba/Al LiF/AI bilayers, and has mirror-like reflectivity if its thickness is over 20 nanometers. The high reflectivity results in poor readability or low contrast of the devices in lighted environments.

An attempt to solve the reflection problem is to place a circular polarizer in front of the display panel. However, circular polarizers can block about 60% of the emitted light from the OLED and increase module thickness and cost considerably. The polarizer is typically located such that the substrate lies between the polarizer and the OLED.

Another attempt in improving display contrast uses an interfering mechanism as an additional layer within an electronic device. The additional layer lies between an organic light-emitting layer and either of the electrodes. The interfering mechanism is limited to a pre-selected wavelength. The actual contrast ratio of the organic electronic device not only depends on the ambient light, but also on the emitting light of the organic electronic device itself. The integration of such technology in a full color display and making the final product work in variable environments prove to be difficult. The interference film also adds manufacturing complexity and reduces yields. Such complications and performance degradation are undesirable.

Still another attempt to improve display contrast includes using a light absorbing material between pixels of an electroluminescent display, wherein the light absorbing material effectively lies within the substrate. However, light-absorbing materials at such a location (within the substrate) may not provide optimal contrast.

### SUMMARY OF THE INVENTION

An organic electronic device has an improved contrast ratio by lowering background luminescence from ambient radiation source(s). The organic electronic device comprises a first electrode, a second electrode, and an organic active layer, wherein the first electrode lies on an opposite side of the organic active layer compared to the second electrode, and at least one layer selected from the first electrode, the second electrode, a hole-transport layer, an electron-transport layer, and the organic active layer is configured to achieve low L_{background}.

Background luminescence may be lowered by increasing absorption of ambient radiation, by reducing reflection of ambient radiation, or a combination of the two. Lower background luminescence can be achieved by using one or more black layers or lattices that are incorporated within the organic electronic device. Also, a large number of materials can be used for high absorbance layers. A change in materials for the electronic device may not be needed, and therefore, new material compatibility issues may not arise. Further, from an electronic performance standpoint, some layers may not be too sensitive to thickness and a plurality of narrow ranges of thicknesses may be used for a layer to allow a layer to have the proper electrical and optical properties. The embodiments obviate the need for a circular polarizer.

In one embodiment, the organic electronic device can include an organic active layer and an electrode. The electrode may act as an anode or a cathode for the organic electronic device. The electrode has a side opposite the organic active layer. The electrode includes an electrode layer lying at the side opposite the organic active layer. The electrode layer is configured to achieve low L_{background}. The electrode layer includes a transition metal or an elemental metal. The elemental metal may be selected from a group consisting of Au, Cr, Si, and Ta. In one specific embodiment, the electrode layer further includes an oxide of the elemental metal. Both electrodes may each include an electrode layer that is configured to achieve low L_{background}.

When reflectivity of a layer is being configured to achieve low L_{background}, the range of thicknesses (d₁-d₂) for the layer can be determined by:
2ηd₁ cos (θ)+φ=(m+¼)/λ (Equation 1)
2ηd₂ cos (θ)+φ=(m+¾)/λ (Equation 2)
wherein:
η is a refractive index of a material of the layer at a specific wavelength (λ);
d₁ is a first thickness of the layer;
d₂ is a second thickness of the layer;
θ is an angle of incident radiation;
φ is a total phase change of radiation reflected by an ideal reflector at λ;
m is an integer; and
λ is the specific wavelength.
   In one embodiment, λ may be 540 nm, and θ is 45°.

If interfacial reflectivity between two adjacent layer within the organic electronic device is being configured to achieve low L_{background}, the interfacial reflectivity may be no greater than about 30 percent, wherein the interfacial reflectivity is determined by:

$$R = \frac{{I}_{reflected}}{{I}_{incident}} = {( \frac{{η}_{x} - {η}_{y}}{{η}_{x} + {η}_{y}} )}^{2} \qquad ( Equation 3 )$$

wherein:
ηₓ is a refractive index of the a first layer; and
η_{y} is a refractive index of a second layer lying immediately adjacent to the first layer.

In another aspect, a process for designing an organic electronic device includes the steps of determining a specific wavelength for reflected ambient radiation; determining η at the specific wavelength for a material; and determining a range of thicknesses of a layer of the material, wherein the range of thicknesses is d₁-d₂. Equations 1 and 2 can be used to determine d₁ and d₂. The layer can be selected from a group consisting of an organic active layer, a hole-transport layer, and an electron-transport layer or a layer with an electrode.

In still a further embodiment, a process for designing an organic electronic device includes the steps of determining ηₓ at a specific wavelength for a first material of a first layer; and determining η_{y} at the specific wavelength for a second material of a second layer immediately adjacent to the first layer. The interfacial reflectivity at the first and second layers is no greater than about 30 percent, wherein the interfacial reflectivity is determined by Equation 3 previously given.

The foregoing general description and the following detailed description are exemplary and explanatory only and are not restrictive of the invention, as defined in the appended claims.

### BRIEF DESCRIPTION OF THE DRAWINGS

The invention is illustrated by way of example and not limitation in the accompanying figures.

FIG. 1 includes an illustration of how radiation may be reflected or transmitted by layers and at interfaces between the layers.

FIG. 2 includes an illustration of a plan view of a black lattice that includes openings for pixels.

FIG. 3 includes an illustration of a cross-sectional view of a portion of an organic electronic device including the black lattice within FIG. 2 showing how the black lattice may reduce the amount of ambient radiation re-emitted from an electronic device and may reduce cross talk between pixels.

FIG. 4 includes an illustration of a cross-sectional view of an organic electronic device to show some potential locations for a black layer.

FIG. 5 includes an illustration of a cross-sectional view of an organic electronic device that includes electrodes that incorporate black layers.

FIG. 6 includes an illustration of a plan view of locations of the black lattice with respect to electrodes for passive matrix and active matrix displays.

FIG. 7 includes an illustration of a plan view of other structures that can be used for the black lattice.

FIGS. 8-13 include illustrations of views of a portion of an array of organic electronic devices in accordance with one set of embodiments.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION

An organic electronic device has an improved contrast ratio by lowering background luminescence from ambient radiation source(s). Background luminescence may be lowered by increasing absorption of ambient radiation, by reducing reflection of ambient radiation, or a combination of the two. Lower background luminescence can be achieved by using one or more black layers or lattices that are incorporated within the organic electronic device. Also, a large number of materials can be used for high absorbance layers. A change in materials for the electronic device may not be needed, and therefore, new material compatibility issues may not arise. Further, from an electronic performance standpoint, some layers may not be too sensitive to thickness and a plurality of narrow ranges of thicknesses may be used for a layer to allow a layer to have the proper electrical and optical properties. The embodiments obviate the need for a circular polarizer.

Other features and advantages of the invention will be apparent from the following detailed description, and from the claims. The detailed description first addresses Definitions and Clarification of Terms followed by the Optical Principles and Design Considerations, Black Lattice and Black Layer Structures, Materials for the Black Lattice and Black Layer, Fabrication of an Organic Electronic Device, Operating the Organic Electronic Device, Alternative Embodiments, Advantages, and finally Examples.

1. Definitions and Clarification of Terms

Before addressing details of embodiments described below, some terms are defined or clarified. As used herein, the terms “array,” “peripheral circuitry” and “remote circuitry” are intended to mean different areas or components. For example, an array may include a number of pixels, cells, or other electronic devices within an orderly arrangement (usually designated by columns and rows) within a component. These electronic devices may be controlled locally on the component by peripheral circuitry, which may lie within the same component as the array but outside the array itself. Remote circuitry can control the array by sending signals to or receiving signals from the array (typically via the peripheral circuitry).

The term “black” when used to modify a layer or material depends on the location within the device and is not meant to denote or connote a specific color. Within a pixel, when the black layer or material lies between an organic active layer and a user side of the device, the black layer or material may have low reflectivity of radiation at a targeted wavelength or spectrum. At all other locations, such as surrounding all or part of a pixel (from a plan view) or lying on a side of the organic active layer opposite the user side, the black layer or material transmits no more than approximately 10% of radiation at a targeted wavelength or spectrum of radiation.

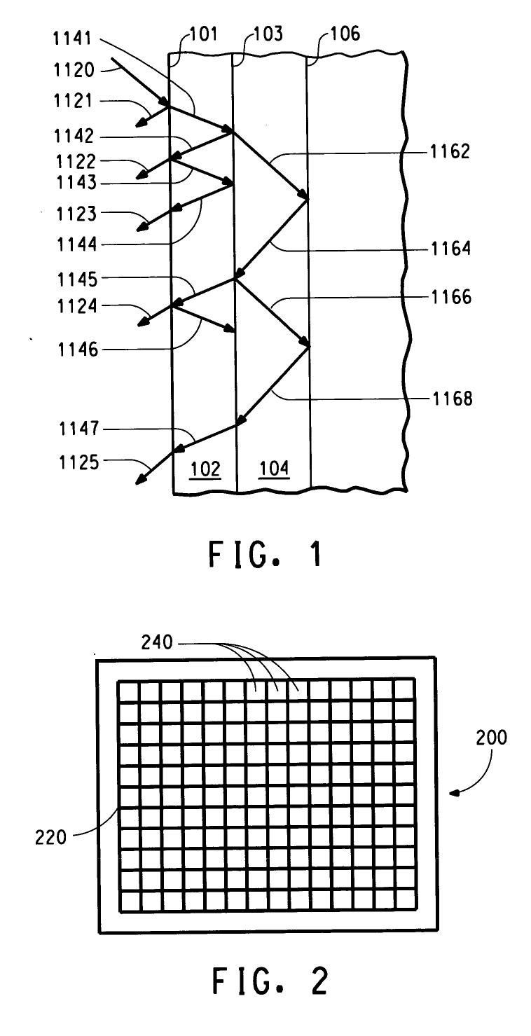

“Black lattice” is a patterned black layer that, from a plan view, surrounds at least part of a pixel. See FIGS. 2 and 6 and their related text.

The term “configure” and its variants are intended to mean that a material or a layer, its thickness, or a relationship between two layers has been selected to improve the degree to which a purpose is achieved. For example, the reflectivity of a single layer may have a range of thicknesses that keep reflectivity from reaching too high of a level. In another example, the materials for layers on opposite side of an interface may be selected to have interfacial reflectivity below a predetermined amount. Note that “configuring” does not require that maximum of optimum degree be reached.

The term “electron withdrawing” is synonymous with “hole injecting.” Literally, holes represent a lack of electrons and are typically formed by removing electrons, thereby creating an illusion that positive charge carriers, called holes, are being created or injected. The holes migrate by a shift of electrons, so that an area with a lack of electrons is filled with electrons from an adjacent layer, which give the appearance that the holes are moving to that adjacent area. For simplicity, the terms holes, hole injecting, and their variants will be used.

The term “elevation” is intended to mean a plane that is substantially parallel to a reference plane. The reference plane is typically the primary surface of the substrate from which at least a portion of the electronic device is formed.

The term “essentially X” is intended to mean that the composition of a material is mainly X but may also contain other ingredients that do not detrimentally affect the functional properties of that material to a degree at which the material can no longer perform its intended purpose.

The term “high absorbance” when used to modify a layer or material is intended to mean no more than approximately 10% of the radiation at the targeted wavelength or spectrum is transmitted through the layer or material.

The term “interfacial reflectivity” is intended to mean radiation that is reflected at an interface where materials on each side of the interface have a different refractive index compared to each other. The materials on each side of the interface may be of the same or different phase state (solid-solid, gas-solid, liquid-solid, etc.).

The term “low L_{background}” is intended to mean no more than approximately 30% of the ambient light incident on the device is reflected from the device using the Ambient Contrast Ratio test (discussed later in this specification).

The term “low work function layer” is intended to mean a layer having a work function no greater than about 4.4 eV. The term “high work function layer” is intended to mean a layer having a work function of at least approximately 4.4 eV.

The term “most” is intended to mean more than half.

The term “organic electronic device” is intended to mean a device including one or more organic semiconductor layers or materials. Organic electronic devices include: (1) devices that convert electrical energy into radiation (e.g., an light-emitting diode, light emitting diode display, or diode laser), (2) devices that detect signals through electronics processes (e.g., photodetectors (e.g., photoconductive cells, photoresistors, photoswitches, phototransistors, phototubes), IR detectors), (3) devices that convert radiation into electrical energy (e.g., a photovoltaic device or solar cell), and (4) devices that include one or more electronic components that include one or more organic semiconductor layers (e.g., a transistor or diode).

The term “user side” of an electronic device refers to a side of the electronic device adjacent to the transparent electrode and principally used during normal operation of the electronic device. In the case of a display, the side of the electronic device seen by a user would be a user side. In the case of a detector or voltaic cell, the user side would be the side that principally receives radiation that is to be detected or converted to electrical energy. Note that some devices may have more than one user side.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present). Also, use of the “a” or “an” are employed to describe elements and components of the invention. This is done merely for convenience and to give a general sense of the invention. This description should be read to include one or at least one and the singular also includes the plural unless it is obvious that it is meant otherwise.

Group numbers corresponding to columns within the periodic table of the elements use the “New Notation” convention as seen in the CRC Handbook of Chemistry and Physics, 81^{st} Edition (2000).

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

To the extent not described herein, many details regarding specific materials, processing acts, and circuits are conventional and may be found in textbooks and other sources within the organic light-emitting diode display, photodetector, and semiconductor arts.

2. Optical Principles and Design Considerations

Before turning to the embodiments, some optical principles are addressed to improve clarity of the description. To quantitatively characterize the contrast of OLED devices, Contrast Ratio, “CR,” is introduced using the following equation

$$CR = \frac{{L}_{ON} + {L}_{background}}{{L}_{OFF} + {L}_{background}} \qquad ( Equation 4 )$$

L_{ON} is the luminance of a turned-on OLED device. L_{OFF} is the luminance of an off OLED device. L_{background} is the reflected ambient light from the device. CR is dependent on the luminance of the surroundings. For a bright environment, e.g. under direct sun, the contrast ratio is lower than that measured under low-light conditions. In the flat panel display industry, two standard tests are used for the contrast ratio. One is the Dark Room Contrast Ratio, and the other is the Ambient Contrast Ratio. The experimental set-up and procedures are detailed in “Flat Panel Display Measurements Standard” by the Video Electronics Standards Association Display Metrology Committee (“VESA”). In the following examples, the contrast ratios referred to within this specification are obtained using the conditions set in the Ambient Contrast Ratio test. By using a black lattice or a combination of a black lattice and a black layer, CR can improve by at least approximately 50% compared to the CR of the same array without the black lattice or combination.

CR can be improved by increasing L_{ON} or decreasing L_{OFF} or L_{background}. However, changing L_{ON} or L_{OFF} may cause unintended complications related to device performance. Therefore, CR can be improved by getting L_{background} as close to zero as possible. In one embodiment, the electronic device may have L_{background} that is no more than approximately 30% of the incident ambient light, L_{incident}, reaching the device. In other embodiments, L_{background} may be only approximately 10% or even 1% percent of L_{incident}. One way to reduce L_{background} is to use materials that absorb as much ambient radiation as possible, reflect as little ambient radiation as possible, or use a combination of high absorbance and low reflectance. Note that the organic electronic device may include many different layers, and therefore, each of the layers individually or in any combination may need to be considered.

FIG. 1 illustrates the concepts of absorbance and reflectance. FIG. 1 includes a first layer 102, a second layer 104, and a mirror-like surface 106. Incident radiation 1120, L_{incident}, may be reflected at surface 101 as radiation 1121, or be at least partially transmitted, illustrated as radiation 1141. At the interface 103 between the first layer 102 and second layer 104, radiation 1141 may be reflected towards surface 101 as radiation 1142. Radiation 1142 may be transmitted out of the device as radiation 1122 or reflected at surface 101 as illustrated as radiation 1143, which may be reflected at interface 103 as radiation 1144 and emitted as radiation 1123. Although not shown, some of radiation 1143 is at least partially transmitted though layer 104. The radiation can continue to pass along layer 102 similar to a waveguide but such radiation is not shown in FIG. 1.

Note that at least some of the radiation is absorbed by layer 102 each time it passes through the layer. Also, some of the radiation reaching interface 103 can enter layer 104. Therefore, radiation 1121 has a greater intensity than radiation 1122, which has a greater intensity than radiation 1123. The significance of the diminished intensity will be addressed later in this specification.

Continuing with FIG. 1, at least part of radiation 1141 may be transmitted through the layer 104, illustrated as radiation 1162. Because radiation 1162 reaches the mirror-like surface 106, nearly all radiation that reaches the surface 106 is reflected as shown by radiation 1164. At the interface 103, part of radiation 1164 may be reflected as shown by radiation 1166 or transmitted through the layer 102 as shown by radiation 1145. Similar to the layer 102, the layer 104 may act as a waveguide and include radiation 1166, 1168, and other radiation, not shown.

Some of the radiation that is transmitted through layer 102 (shown by arrows 1145 and 1147) may be emitted as shown by radiation 1124 and 1125. Part of radiation 1145 is reflected at surface 101 as illustrated by arrow 1146. Note that the “bouncing” of the radiation within a layer and transmission or emission from a layer can continue but is not shown in FIG. 1.

If only absorbance of layer 102 is considered, reflected radiation 1121 may be too high. If only low reflectivity of the first layer 102 is considered, radiation passing through the second layer 104 and reflected by surface 106 and re-emitted from the device (see radiation 1141, 1162, 1164, 1145, and 1124) may be too high. Therefore, both reflectivity and absorbance for all layers may be considered to ensure that L_{background} can be sufficiently reduced.

Absorbance of a layer having a substantially uniform composition can be empirically determined and data from absorbance (or transmittance) measurements collected from the empirical tests can be used to generate an equation for absorbance as a function of thickness. Each material may have its own absorbance equation as a function of thickness. Note that absorbance and transmittances are complementary mechanisms. Radiation that initially enters a layer may have some the radiation absorbed and the rest of the radiation transmitted. Therefore, skilled artisans may use transmission concepts rather than absorbance concepts. Therefore, a high absorbance material has low transmission at the targeted wavelength or spectrum or radiation.

Reflectivity or a thickness of a single layer can be determined by the equation below.
2ηd cos (θ)+φ=(m+½)/λ (Equation 5)
wherein,
η is the refractive index of the selected material at a specific wavelength (λ);
d is the thickness of the layer;
θ is the angle of incident radiation;
φ is the total phase change of the radiation reflected by an ideal reflector at λ;
m is an integer; and
λ is the specific wavelength.

For the visible light spectrum, 540 nm may be used for a specific wavelength for determining an appropriate thickness of a low reflectivity layer, and a metal mirror can be used as an ideal reflector. Clearly, other wavelengths can be used depending on the radiation being contemplated. Theta may be selected to be approximately 45 degrees.

Equation 5 is a sinusoidal function of thickness. Therefore, multiple, single point thicknesses within a large range can be used to attain low reflectivity for a specific wavelength. Equation 5 may be used for radiation outside the visible light spectrum, such as infrared or ultraviolet radiation.

In manufacturing, use of a single point, target thicknesses may be difficult to achieve. Therefore, a pair of equations below can be used to determine a range of acceptable thicknesses that correspond to the target thickness, “d” (from Equation 5).
2ηd₁ cos (θ)+φ=(m+¼)/λ (Equation 1)
2ηd₂ cos (θ)+φ=(m+¾)/λ (Equation 2)

In Equations 1 and 2, “d” from Equation 5 is replaced by “d₁” and d₂, respectively, and “m+½” is replaced by “m+¼” and “m+¾,” respectively. For Equation 5, “m+½” represents radiation being out of phase by +180° to achieve maximum destructive interference. The “m+¼” (Equation 1) and “m+¾” (Equation 2) represents radiation being out of phase by +90° and +270°, respectively. If the range is too high (i.e., not far enough out of phase), the range may be narrowed to “m+⅜” and “m+⅝” for radiation being out of phase by +135° and +225°, respectively. Along similar lines, the range of angles used for being out of phase may be increased (further from “m+½”) if reflectivity is still acceptable. Note that the numbers selected do not have to be symmetric about “m+½.”For example, “m+⅜” and “m+0.6” could be used. After the acceptable level of being out of phase is selected, the d₁ and d₂ thicknesses for a specific material can be calculated. As long as the thickness does not lie outside the range, reasonably acceptable low reflectivity may be achieved.

A process for designing an organic electronic device using Equations 1 and 2 can include the steps of determining a specific wavelength for reflected ambient radiation and determining η at the specific wavelength for the material of the layer. For light, the specific wavelength chosen may be 540 nm. Note that other wavelengths could be chosen if other wavelengths of radiation are more relevant to the reflectivity. The determination of refractive index can be made by looking up a refractive index for a specific material using a handbook or by forming the layer (by itself or in combination with others) over a substrate and using an ellipsometer or other optical measuring tool to obtain the refractive index using conventional techniques. After the specific wavelength and refractive indices are determined, the process can continue with determining a range of thicknesses (d₁-d₂) for the layer by using Equations 1 and 2.

The reflectivity of each interface between immediately adjacent layers can be determined by the equation for interfacial reflectivity below.

$$R = \frac{{I}_{reflected}}{{I}_{incident}} = {( \frac{{η}_{x} - {η}_{y}}{{η}_{x} + {η}_{y}} )}^{2} \qquad ( Equation 3 )$$

wherein,
ηₓ and η_{y} are the refractive indices of the materials within the layers on opposite sides of the interface.

A process for designing an organic electronic device include determining ηₓ at a specific wavelength for a first material of a first layer; and determining η_{y} at the specific wavelength for a second material of a second layer immediately adjacent to the first layer. The determination of refractive indices has been previously described. Note that the closer the refractive indices at both sides of the interface become closer to each other, the lower the interfacial reflectivity. In one embodiment, the interfacial reflectivity at the first and second layers may be no greater than about 30 percent. For example, assume that Si₃N₄ and SiO₂ layers lie immediately adjacent to each other. Si₃N₄ has a refractive index of 2.00 and SiO₂ has a refractive index of 1.45. Using those refractive indices, the interfacial reflectivity is approximately 0.025 or 2.5% of the radiation incident on the interface.

While some of the design methodology has been described, a more accurate solution may be obtained by using a series of equations for each of the layers and interfaces can be written using absorbance (for each pass through each layer), the single layer reflectivity (Equation 2), and the interfacial reflectivity (Equation 3) equations. In theory, the number of equations may be very large. However, some simplifying assumptions may be made. For example, each of radiation 1121 and 1122 may be significant compared to radiation 1123. Therefore, radiation 1123 may be ignored. Similarly, radiation 1124 and 1125 may be significant, whereas, the “next reflection” (not shown in FIG. 1) from layer 104 being emitted from the device may be insignificant. Further, mirror-like surface 106 may be assumed to reflect all radiation reaching it. If surface 106 is black, it may absorb all radiation.

A computer program using the equations and simplifying assumptions may be run to determine how the L_{background} is affected by the thickness of any one or more layers or the composition of the layers. L_{background} can be the sum of radiation 1121-1125. Note that radiation 1121-1125 may have different intensities and different phases. By changing the thickness(es) and composition(s) of the layer(s), the intensities and phases can be changed to cause destructive interference to reduce L_{background}.

Any combination of reflectivity and absorbance equations may be used. Many devices may have several layers instead of the two shown in FIG. 1. The equations may only focus on one layer or a subset of the layers. After reading this specification, skilled artisans will appreciate the types and number of equations to be used.

3. Black Lattice and Black Layer Structures

The concepts described herein can be used to determine compositions and thicknesses to achieve a black layer or a black lattice. The black feature(s), whether black lattice(s) or black layer(s), can be inserted anywhere within the devices, e.g. at the same elevation as the electrodes, at an elevation between the electrodes and organic layers, or at an elevation between organic layers.

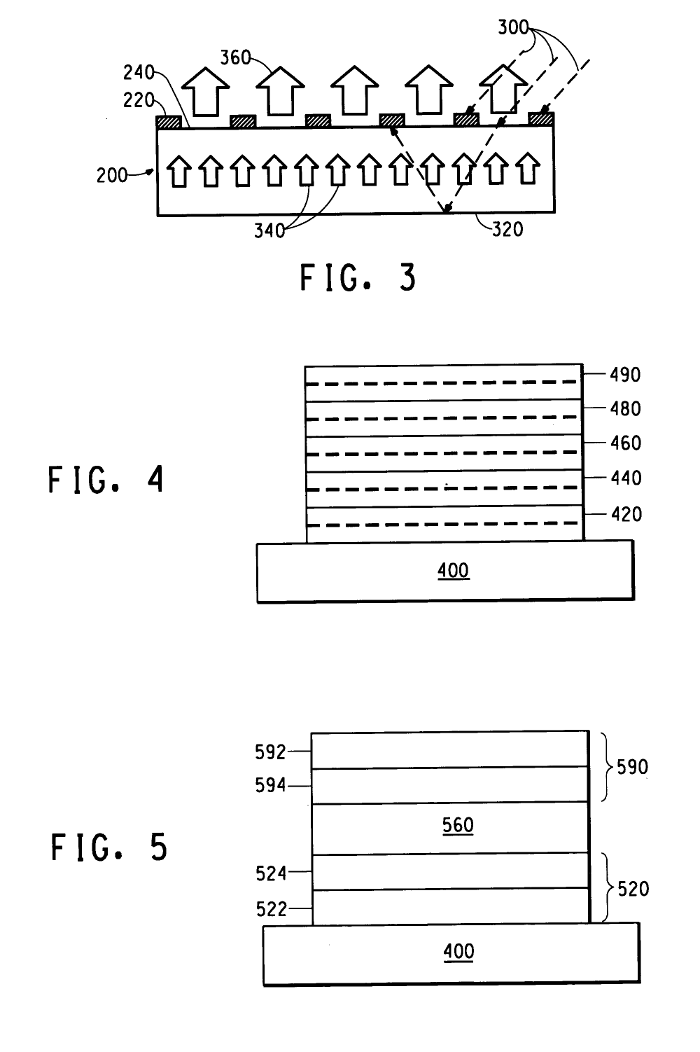

FIGS. 2 and 3 include a black lattice that can be used in one embodiment to absorb ambient light. FIG. 2 includes an illustration of a plan view of an array 200 of pixels having a black lattice 220. Pixels can emit light through the openings 240 within the black lattice 220. FIG. 3 includes an illustration of a cross-sectional view of a portion of array 200 shown in FIG. 2. Some of the incident ambient light 300 is absorbed by the black lattice 220. Other portions of the ambient light 300 are reflected off a surface 320 within the array 200 and absorbed by another part of the black lattice 220. Light 340 from the pixels can pass through openings 240 in the lattice 220 as emitted light 360.

Referring to FIG. 4, the black lattice may be formed at almost any elevation over a substrate 400 within an organic electronic device. More specifically, the black lattice (illustrated by the black dashed lines) may be formed at a first electrode (e.g., anode) elevation 420, hole-transport elevation 440, organic active layer elevation 460, electron-transport elevation 480, or second electrode (e.g., cathode) elevation 490.

FIG. 5 includes an illustration where a black layer may be used as part of an electrode. An organic electronic device may include the substrate 400, a first electrode 520 that acts as an anode, an organic active layer 560, and a second electrode 590 that acts as a cathode. Although not shown, a hole-transport, an electron-transport, or other optional layer(s) may be present. The first electrode 520 may include a conductive black layer 522 and a high work function layer 524, and the second electrode 590 may include a low work function layer 594 and a conductive black layer 592. Note that the black layers 522 and 592 are the furthest from the organic active layer 560 and one or both may be closest to the user side(s) of the organic electronic device. Note that the black layers 522 and 592 may be designed to have low reflectivity so that a significant portion of the radiation to be emitted or detected by the organic electronic device can pass through the black layer.

In an alternative embodiment, a hole-transport layer, an electron-transport layer, or the organic active layer 560 may include a black layer by itself or in combination with other layers. The ability to integrate a black layer at many different elevations and layers allows for better design flexibility.

FIG. 6 includes an illustration of exemplary designs of the black lattice for use with a passive matrix and an active matrix device. In a passive matrix device, the electrodes may be part of conductive strips 602. Each of the strips 602 has opposing sides 606 and the members of the black lattice 604 are substantially parallel to the opposing sides 606. In FIG. 6, the black lattice 604 lies between the pixels in the same row but not the same column. Note that the orientation of the strips 602 and members of the black lattice 604 could be rotated by 90%, in which case, the members of the black lattice 604 lies between the pixels in the same column but not the same row.

For active matrix devices, electrodes 622 may be in the form of pads instead of strips. In this embodiment, black matrices 624 may laterally surround the electrodes 622 on all sides and may additionally protect the drive circuitry from radiation. Other designs are possible, and only some are described herein to illustrate and not limit the invention.

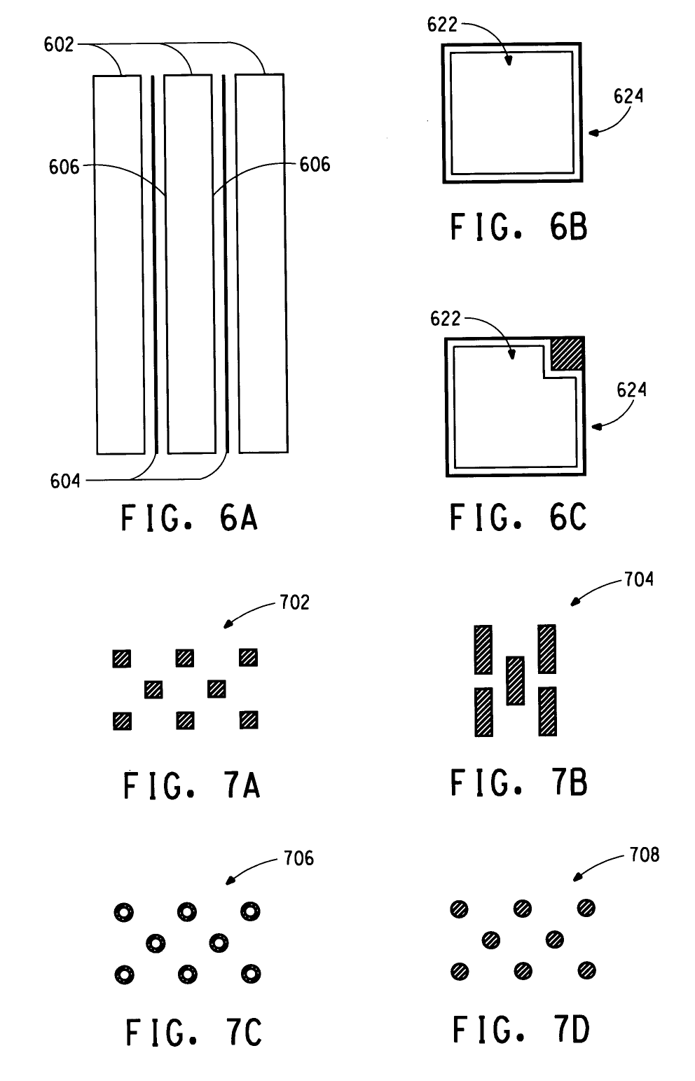

FIG. 7 illustrates that a number of different designs may be used for members in a black lattice. For example, squares 702, rectangles 704, rings 706, and circles 708 may be used instead of straight, continuous, solid lines. Many other designs are possible, and only some are describe herein to illustrate and not limit the invention.

4. Materials for the Black Lattice and Black Layer

A nearly limitless number of materials can be used for a black lattice or layer. The electrical characteristics or potential materials can vary from conductive to semiconductive to insulating. A potential material for a black lattice or layer can comprise one or more inorganic materials selected from elemental metals (e.g., W, Ta, Cr, or In); metal alloys (e.g., Mg—Al or Li—Al); metal oxides (e.g., CrₓO_{y}, FeₓOy, In₂O₃, SnO, or ZnO); metal alloy oxides (e.g., InSnO, AlZnO, or AlSnO); metal nitrides (e.g., AlN, WN, TaN, or TiN); metal alloy nitrides (e.g., TiSiN or TaSiN); metal oxynitrides (e.g., AlON or TaON); metal alloy oxynitrides; Group 14 oxides (e.g., SiO₂, or GeO₂); Group 14 nitrides (e.g., Si₃N₄, or silicon-rich Si₃N₄); and Group 14 oxynitrides (e.g., silicon oxynitride, or silicon-rich silicon oxynitride); Group 14 materials (e.g., graphite, Si, Ge, SiC, or SiGe); Group 13-15 semiconductor materials (e.g., GaAs, InP, or GaInAs); Group 12-16 semiconductor materials (e.g., ZnSe, CdS, or ZnSSe); and combinations thereof.

An elemental metal refers to a layer that consists essentially of a single element and is not a homogenous alloy with another metallic element or a molecular compound with another element. For the purposes of metal alloys, silicon can be considered a metal. In many embodiments, a metal, whether as an elemental metal or as part of a molecular compound (e.g., metal oxide, or metal nitride) may be a transition metal (an element within Groups 3-12 in the Periodic Table of the Elements) including chromium, tantalum, or gold.

A potential material for a high absorbance layer can comprise one or more organic materials selected from polyolefins (e.g., polyethylene or polypropylene); polyesters (e.g., polyethylene terephthalate or polyethylene naphthalate); polyimides; polyamides; polyacrylonitriles and polymethacrylonitriles; perfluorinated and partially fluorinated polymers (e.g., polytetrafluoroethylene, copolymers of tetrafluoroethylene and polystyrenes); polycarbonates; polyvinyl chlorides; polyurethanes; polyacrylic resins, including homopolymers and copolymers of esters of acrylic or methacrylic acids; epoxy resins; Novolac resins, organic charge transfer compounds (e.g., tetrathiafulvalene tetracyanoquinodimethane (“TTF-TCNQ”)), and combinations thereof.

After selecting a material, skilled artisans appreciate that the thickness of the material can be tailored to achieve low L_{background} using the equations previously described. Although the calculations can yield a single thickness, typically a range of acceptable thicknesses may be given for manufacturing reasons. As long as the thickness does not lie outside the range, reasonably acceptable L_{background} may be achieved.

Skilled artisans appreciate that they may be able to achieve L_{background} without having to change the composition of materials of the layers currently used. Such a change could cause problems with device performance, problems with processing or materials incompatibility, an entire re-design of the organic electronic device, or the like. The thicknesses for layers can be chosen to give acceptable electrical and radiation-related performance. For example, electrodes may have a minimum thickness determined by resistance, electromigration, or other device performance or reliability reasons. The maximum thickness may be limited by step-height concerns, such as step coverage or lithography constraints for subsequently formed layers. Still, the range between the minimum and maximum thicknesses for an electrode layer may allow a plurality of thicknesses to be chosen that still give low L_{background} while achieving the proper device performance.

5. Fabrication of an Organic Electronic Device

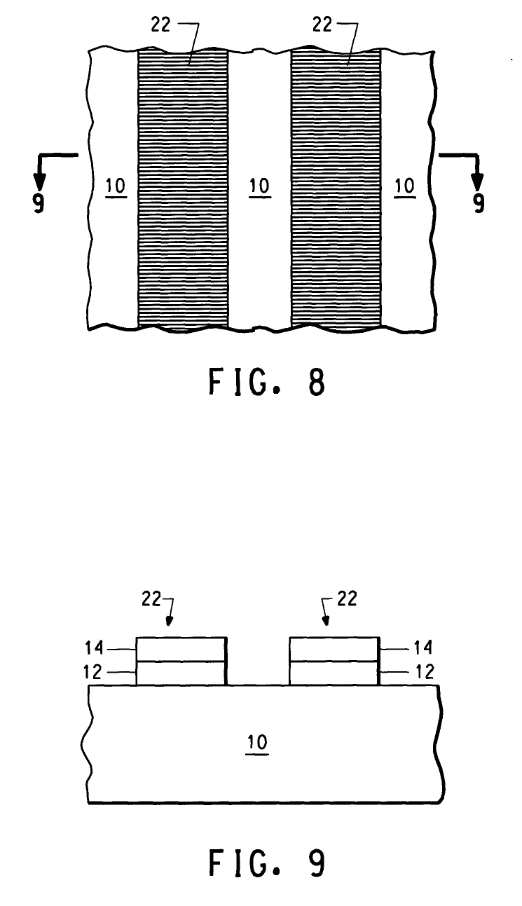

Attention is now directed to details for a first set of embodiments that is shown in FIGS. 8-13 in which low L_{background} and hence high contrast can be achieved by using a black lattice or a black lattice in combination with a black layer. The materials used for the organic electronic device layers are typically determined by the desired performance criteria that are related to electronic and radiation (emitted or received by an organic active layer) constraints. Additional constraints related to physical limitations (thicknesses and widths of features and spaces) may also be considered.

In a first embodiment, first electrodes 22 are formed over a substrate 10 as illustrated in FIG. 8. In this embodiment, the first electrodes 22 are strips of conductors that act as anodes. The substrate 10 can include nearly any type and number of materials including conductive, semiconductive, or insulating materials. If substrate 10 includes a conductive base material, care may need to be exercised to ensure the proper electrical isolation between parts of a component. The conductive base material may be covered by an insulating layer having a sufficient thickness to reduce the effects of parasitic capacitance between overlying electrodes or conductors and the underlying conductive base material. Skilled artisans are capable of determining an appropriate thickness of an insulating layer to reduce the effects of undesired capacitive coupling.

The substrate 10 may comprise a ceramic material (e.g., glass or alumina) or a flexible substrate comprising at least one polymeric film. Examples of suitable polymers for the polymeric film may be selected from one or more materials containing essentially polyolefins (e.g., polyethylene or polypropylene); polyesters (e.g., polyethylene terephthalate or polyethylene naphthalate); polyimides; polyamides; polyacrylonitriles and polymethacrylonitriles; perfluorinated and partially fluorinated polymers (e.g., polytetrafluoroethylene or copolymers of tetrafluoroethylene and polystyrenes); polycarbonates; polyvinyl chlorides; polyurethanes; polyacrylic resins, including homopolymers and copolymers of esters of acrylic or methacrylic acids; epoxy resins; Novolac resins; and combinations thereof. When multiple polymeric films are used, they can be joined together with appropriate adhesives or by conventional layer producing processes including known coating, co-extrusion, or other similar processes. The polymeric films generally have a thickness in the range of approximately 12-250 microns (0.5-10 mils). When more than one film layer is present, the individual thicknesses can be much less.

Although the polymeric film(s) may contain essentially one or more of the polymers described above, the film(s) may also include one or more conventional additive(s). For example, many commercially available polymeric films contain slip agents or matte agents to prevent the layers of film from sticking together when stored as a large roll.

For flexible substrates that include a plurality of polymeric films, at least one layer of barrier material may be sandwiched between at least two of the polymeric films. In one non-limiting example, a polyester film approximately 25-50 microns (1-2 mils) thick can be coated with an approximately 2-500 nm thick layer of silicon nitride (SiNₓ) using plasma enhanced chemical vapor deposition or physical vapor deposition (conventional rf magnetron sputtering or inductively-coupled plasma physical vapor deposition (IMP-PVD)). The silicon nitride layer can then be overcoated with a solution of acrylic resin that is allowed to dry, or an epoxy or novolac resin followed by curing. Alternatively, the polyester film within the silicon nitride layer can be laminated to a second layer of polyester film. The overall thickness of the composite structure is generally in the range of approximately 12-250 microns (0.5-10 mils), and more typically 25-200 microns (1-8 mils). Such overall thickness can be affected by the method used to apply or lay down the composite structure.

After reading this specification, skilled artisans appreciate that the selection of material(s) that can be used for the substrate 10 is widely varied. Skilled artisans are capable of selecting the appropriate material(s) based on their physical, chemical, and electrical properties. For simplicity, the material(s) used for this base are referred to as substrate 10.

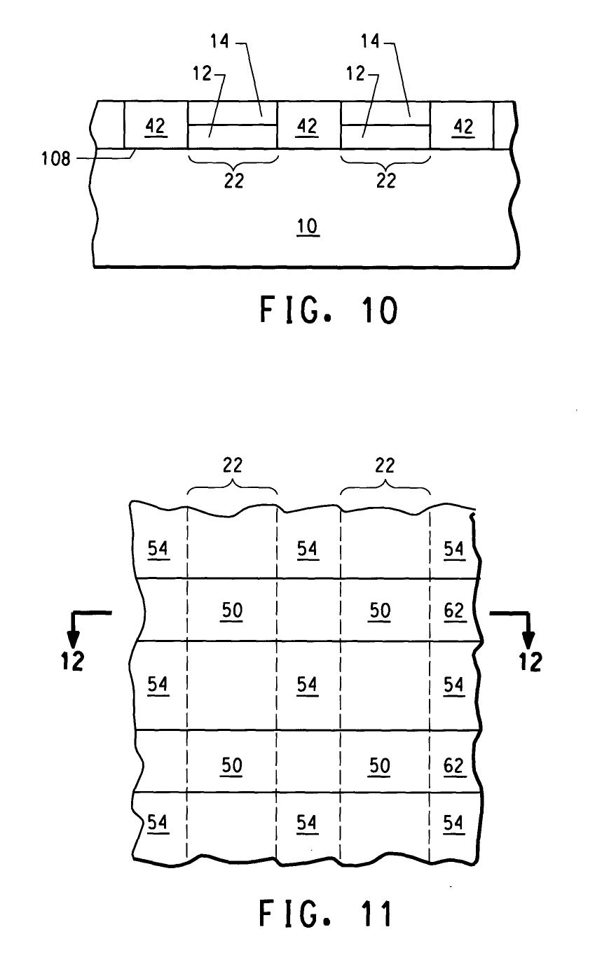

The first electrodes 22 may include a conductive black layer 12 and a high work function layer 14 as shown in FIG. 9. The conductive black layer 12 can include nearly any conductive material. The black layer 12 should have low absorbance because radiation needs to pass through the black layer 12 during the operation of the organic electronic device. Equations 2 and 5 may be used to reduce the effects of reflectivity while still maintaining reasonably low absorbance. In one embodiment, only the single layer reflectance (Equation 5) of the black layer 12 may be used. In other embodiments, reflectance at interfaces (Equation 3) with already existing and subsequently formed layers may be considered. Note that while Equation 5 may be used for device simulations, Equations 1 and 2 may be used to determine an acceptable range of thicknesses for manufacturing purposes.

The high work function layer 14 can include a metal, mixed metal, alloy, metal oxide or mixed-metal oxide. Suitable metal elements within the high work function layer 14 can include the Groups 4, 5, 6, and 8-11 transition metals. If the high work function layer 14 is to be light transmitting, mixed-metal oxides of Groups 12, 13 and 14 metals may be used. Some non-limiting, specific examples of materials for the high work function layer 14 include indium-tin-oxide (“ITO”), zirconium-tin-oxide (“ZTO”), aluminum-tin-oxide (“ATO”), gold, silver, copper, nickel, and selenium. The first electrodes 22 may have a thickness in a range of approximately 10-1000 nm.

A black lattice 42 can be formed over the substrate 10 between the first electrodes 22 as shown in FIG. 10. Unlike the conductive black layer 12, radiation does not need to be transmitted through the black lattice 42. In one embodiment, the black lattice 42 may include a negative-acting resist layer that may include a dye or other chemical to achieve relatively high absorbance of the targeted radiation for the organic electronic device. Other radiation-imageable materials (e.g. positive-acting photoresist, photo-imageable polyimide, etc.) may be used instead of the negative-acting resist layer. Absorbance may be substantially more significant in reducing L_{background} compared to reducing reflectivity. As long as the thickness is above a minimum threshold to achieve the desired absorbance, the thickness can be nearly any thickness above a lower limit. For example, if the thickness for minimum threshold absorbance is 50 nm, black lattice 42 may have nearly a thickness of at least 50 nm.

Returning to FIG. 10, the thickness of the black lattice 42 can be similar to the combined thicknesses of layers 12 and 14, although this is not a requirement. After patterning, the members of the black lattice 42 lie in the spaced-apart regions between the first electrodes 22. The members of the black lattice 42 are electrical insulators and may reduce the likelihood of electrical shorts or conduction paths between adjacent first electrodes 22. Also, the members of black lattice 42 can reduce optical cross talk because the black lattice 42 has high absorbance. In this particular embodiment, the members of the black lattice 42 do not overlie or underlie the first electrodes 22. The first electrodes 22 and the black lattice 42 lie at substantially the same elevation. The significance of having the black lattice 42 and the conductive black layer 12 at the substantially the same elevation is described in the advantages section of this specification.

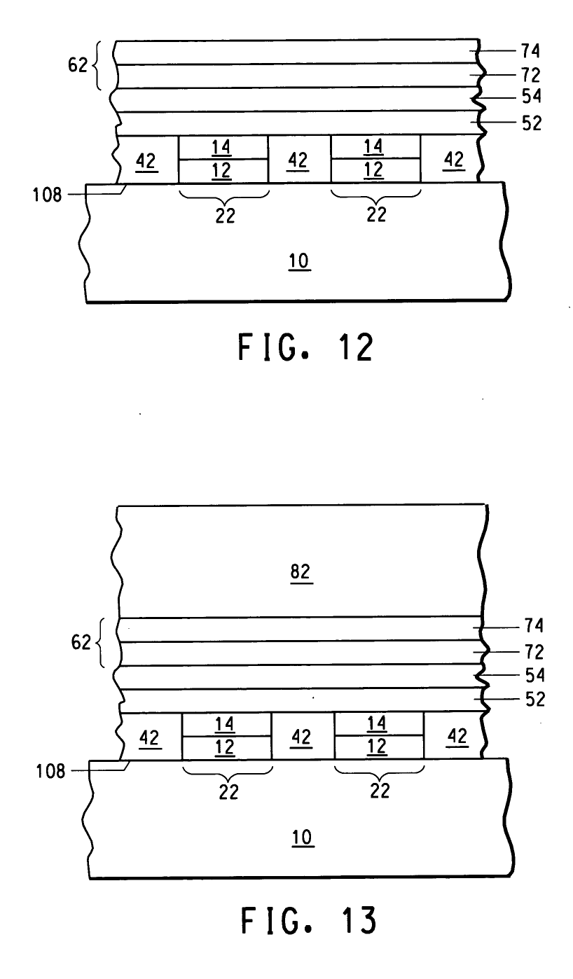

An optional hole-transport layer 52, organic active layer 54, and second electrodes 62 may be sequentially formed over the high work function layer 14 and the black lattice 42 as shown in FIGS. 11 and 12. FIG. 11 includes a plan view of the portion of the array as seen in FIG. 8 after forming the second electrodes 62, and FIG. 12 includes a cross-sectional view at sectioning line 12-12 in FIG. 11.

The hole-transport layer 52 can be used to reduce the amount of damage and potentially increase the lifetime and reliability of the device compared to an organic electronic device where high work function layer 14 would directly contact a subsequently formed organic active layer. Although first electrodes 22 and the optional hole-transport layer 52 are both conductive, typically the conductivity of the first electrodes 22 is significantly greater than the hole-transport layer 52. In one specific embodiment, the hole-transport layer 52 can include an organic polymer, such as polyaniline (“PANI”), poly(3,4-ethylenedioxythiophene) (“PEDOT”), and the like, or an organic charge transfer compound, such as TTF-TCQN and the like. Hole-transport layer 52 typically has a thickness in a range of approximately 30-500 nm.

The composition of the organic actively layer 54 typically depends upon the application of the organic electronic device. When the organic active layer 54 is used in a radiation-emitting organic electronic device, the material(s) of the organic active layer 54 will emit radiation when sufficient bias voltage is applied across the organic active layer 54. The radiation-emitting active layer may contain nearly any organic electroluminescent or other organic radiation-emitting materials.

Such materials can be small molecule materials or polymeric materials. Small molecule materials may include those described in, for example, U.S. Pat. No. 4,356,429 (“Tang”) and U.S. Pat. No. 4,539,507 (“Van Slyke”). Alternatively, polymeric materials may include those described in U.S. Pat. No. 5,247,190 (“Friend”), U.S. Pat. No. 5,408,109 (“Heeger”), and U.S. Pat. No. 5,317,169 (“Nakano”). Exemplary materials are semiconductive conjugated polymers. Examples of such a polymer is poly (phenylenevinylene), referred to as “PPV,” and polyfluorene. The light-emitting materials may be dispersed in a matrix of another material, with or without additives, but typically form a layer alone. The organic active layer generally has a thickness in the range of approximately 40-100 nm.

When the organic active layer 54 is incorporated into a radiation receiving organic electronic device, the material(s) of the organic active layer 54 may include many conjugated polymers and electroluminescent materials. Such materials include for example, many conjugated polymers and electro- and photo-luminescent materials. Specific examples include poly(2-methoxy,5-(2-ethyl-hexyloxy)-1,4-phenylene vinylene) (“MEH-PPV”) and MEH-PPV composites with CN-PPV. The organic active layer 54 typically has a thickness in a range of approximately 50-500 nm.

The organic active layer 54 can be applied over the hole-transport layer 52 from solution using a conventional means, including spin-coating, casting, and printing. The organic active layer 54 can be applied directly by vapor deposition processes, depending upon the nature of the materials. The organic active layer 54 may also be formed by applying an active polymer precursor can be applied and then converted to a polymer, typically by heating. The organic active layer 54 typically has a thickness in a range of approximately 50-500 nm.

Although not shown, an optional electron-transport layer may be formed over the organic active layer 54. The electron-transport layer typically is conductive to allow electrons to be injected from the subsequently formed second electrode (i.e., cathode) and transferred to the organic active layer 54. Although the subsequently formed second electrode and the optional electron-transport layer are conductive, typically the conductivity of the second electrode is significantly greater than the electron-transport layer.

In one specific embodiment, the electron-transport layer can include metal-chelated oxinoid compounds (e.g., Alq₃); phenanthroline-based compounds (e.g., 2,9-dimethyl-4,7-diphenyl-1,10-phenanthroline (“DDPA”), 4,7-diphenyl-1,10-phenanthroline (“DPA”)); azole compounds (e.g., 2-(4-biphenyl)-5-(4-t-butylphenyl)-1,3,4-oxadiazole (“PBD”), 3-(4-biphenyl)-4-phenyl-5-(4-t-butylphenyl)-1,2,4-triazole (“TAZ”); or any one or more combinations thereof. Alternatively, the optional electron-transport layer may be inorganic and comprise BaO, LiF, or Li₂O. The electron-transport layer typically has a thickness in a range of approximately 30-500 nm.

Note that each of the thicknesses of the hole-transport layer 52, organic active layer 54, and optional electron-transport layer may be configured to achieve low L_{background} using Equation 5 for a single targeted thickness or Equations 1 and 2 if a range of thicknesses is desired. Also, the actual material(s) used for the hole-transport layer 52, the organic active layer 54, optional electron-transport layer, and potentially other layers at any one or more interface may be chosen to keep interfacial reflectivity low (Equation 3).

The hole-transport layer 52 and organic active layer 54 may be patterned using a conventional technique to remove portions of the layers 52 and 54 where electrical contacts (not shown) are subsequently made. Typically, the electrical contact areas are near the edge of the array or outside the array to allow peripheral circuitry to send or receive signals to or from the array.

The second electrodes 62 may include at least one of the materials that were described with respect to the first electrodes 22. The second electrodes 62 are conductive strips that act as cathodes and provide a source of electrons that are injected into the organic active layer 54. In this specific embodiment, the second electrodes 62 comprise a low work function layer 72 and a conductive layer 74 that helps to provide good conductivity. The low work function layer 72 can be selected from Group 1 metals (e.g., Li, or Cs), the Group 2 (alkaline earth) metals, the rare earth metals including the lanthanides and the actinides. Conductive polymers with low work functions may also be used. Conductive layer 74 may include nearly any conductive material, including those previously described with respect to layers 12 and 14. The conductive layer 74 is used primarily for its ability to allow current to flow while keeping resistance relatively low. Some exemplary materials for conductive layer 74 include aluminum, silver, copper, and combinations thereof.

A thickness chosen for the second electrodes 62 may be a function of a number of factors. If no radiation is to pass through the second electrodes 62, the materials used and their thicknesses can be chosen without regard to the transmission of radiation. If radiation is to be transmitted through the second electrodes 62, the composition and thickness of layers 72 and 74 may be chosen to allow sufficient radiation to pass through them, similar to first electrodes 22.

Similar to the black conductive layer 12 in the first electrodes 22, the second electrodes 62 may include a black conductive layer that can replace or be used in conjunction with conductive layer 74. If a black conductive layer is used with the second electrodes 62, its location may be farthest from the organic active layer 54 compared to any other layer within the second electrodes 62. The composition and thickness that can be used for the black conductive layer for the second electrodes 62 may be determined using the same or similar consideration as with the black conductive layer 12 of the first electrodes 22.

In many applications, the thickness of the second electrodes 62 may be in a range of approximately 5-500 nm. If radiation is not to be transmitted through the second electrodes 62, the upper limit on the thickness may be extended.

As seen in FIG. 11, the lengths of the second electrodes 62 are substantially parallel to one another and are substantially perpendicular to the lengths of the first electrodes 22 illustrated by dashed lines in FIG. 11. In FIG. 11, the second electrodes 62 and portions of the organic active layer 54 are exposed. The intersections of each pair of first electrodes 22 and second electrodes 62 define the device regions 50. Within each of the device regions 50, the organic active layer 54 lies between the electrodes 22 and 62. Four device regions 50 are illustrated in FIG. 12.

Other circuitry not illustrated in FIGS. 8-12 may be formed using any number of the previously described or additional layers. Although not shown, additional insulating layer(s) and interconnect level(s) may be formed to allow for circuitry in peripheral areas (not shown) that may lie outside the array. Such circuitry may include row or column decoders, strobes (e.g., row array strobe, column array strobe, or the like), sense amplifiers.

A shielding layer 82 can be formed over the second electrodes 62 as illustrated in FIG. 13 to form a substantially completed organic electrical device, such as an electronic display, a radiation detector, or a voltaic cell. The peripheral circuitry is conventional and known to skilled artisans. The shielding layer typically lies on a side of the organic electronic device opposite the user side of the organic electronic device. Still, if desired, radiation may be transmitted through the shielding layer 82. If so, the shielding layer should allow sufficient radiation to pass through it.

6. Operating the Organic Electronic Device

During operation of a display, appropriate potentials are placed on the first and second electrodes 22 and 62 to cause radiation to be emitted from the organic active layer 54. More specifically, when light is to be emitted, a potential difference between the first and second electrodes 22 and 62 allow electron-hole pairs to combine within the organic active layer 54, so that light or other radiation may be emitted from the organic electronic device. In a display, rows and columns can be given signals to activate the appropriate pixels to render a display to a viewer in a human-understandable form.

During operation of a radiation detector, such as a photodetector, sense amplifiers may be coupled to the first electrodes 22 or the second electrodes 62 of the array to detect significant current flow when radiation is received by the electronic device. In a voltaic cell, such as a photovoltaic cell, light or other radiation can be converted to energy that can flow without an external energy source. After reading this specification, skilled artisans are capable of designing the electronic devices, peripheral circuitry, and potentially remote circuitry to best suit their particular needs.

7. Alternative Embodiments

In another embodiment, the black lattice may be formed between the second electrodes 62 similar to the relationship between the black lattice 42 and first electrodes 22. Note that the black lattice could lie between any of the layers within the electronic device. Therefore, most of the black lattice may lie at elevations from the first electrodes 22 to the second electrodes 62. For example, a black lattice could lie between the first electrodes 22 and the hole-transport layer 52, between the hole-transport layer 52 and the organic active layer 54, or between the organic active layer 54 and the second electrodes 62. After reading this specification, skilled artisans will appreciate that one or more black lattices may be formed at many different levels within the electronic device.

In still another embodiment, the black lattice 42 may be formed before forming device structures at the same elevation. Referring to FIG. 10, the black lattice 42 could be formed over the substrate 10 before the first electrodes 22 are formed. In still a further embodiment, the black lattice 220 may be formed in a pattern that defines openings 240 over substrate 10 and first electrodes 22, where the openings 240 correspond to pixel locations. The black lattice 220 may have high absorbance. The hole-transport layer 52 and organic active layer 54 may be formed only within the openings 240. This embodiment may allow for less optical cross talk between rows compared to an embodiment where the black lattice is formed as a series of strips, such as black lattice 42.

In yet another embodiment, the black lattice 42 may have a thickness that corresponds to the thickness of only one layer. For example, the thickness of the black lattice 42 may be similar to the thickness of the conductive layer 12, rather than the thickness of the first electrodes 22 that includes layers 12 and 14.

In still other embodiments, the first and second electrodes 22 and 62 can be reversed. If radiation is to pass through the second electrode 62, the conductive layer(s) of the second electrode 62 may need to have its (their) thickness(es) adjusted so that sufficient radiation passes through the conductive layer(s) when the radiation is to be emitted from or received by the organic active layer 54.

In an alternative embodiment, a black layer, black lattice, or both may be used on both sides of an electronic device. Such a configuration may be useful if each of opposite sides of the organic electronic device is a user side.

8. Advantages

The embodiments as described herein can be adapted to many applications and provide a cost-effective, manufacturable solution to provide relatively higher contrast compared to conventional organic electronic devices. The embodiments obviate the need for a circular polarizer. Low L_{background} can be achieved by using a high absorbance layer or designing the organic electric device for low reflectivity. The layers affected lie at an elevation from the first electrode elevation to the second electrode elevation of the organic electronic device and do not significantly affect the overall thickness of the organic electronic device.

Embodiments as described herein can provide a cost-effective, manufacturable solution to provide relatively higher contrast compared to conventional organic electronic devices because existing materials may be used within an electronic device without requiring the replacement of current materials or insertion of new layers within the electronic device regions. The ability to use the current materials simplifies integration of a high absorbance layer into the electronic device and reduces the likelihood of device re-design, materials compatibility or device reliability issues.

A black lattice or layer may be integrated into a process without significant complications or adverse consequences. The black lattice may be integrated into an organic electronic device at nearly any elevation and can help to reduce background luminescence, electrically isolate parts (e.g., electrodes) or reduce optical cross-talk within the organic electronic device.

A large number of materials can be used for high absorbance layers and to achieve low reflectivity. If new materials are used because they have better electronic or radiation emitting or receiving properties independent of contrast concerns, the principles described herein can used to also achieve low L_{background} with the new materials to keep contrast at acceptable levels.

In one embodiment, the black conductive layer 12 and black lattice 42 lie at substantially the same elevation. From the user side of the electronic device (i.e., at substrate 10), the entire surface of the array may be covered by black features (black layer 12 and black lattice 42) and obviate the need to use black features at other elevations within the device. Concerns regarding reflection from the other layer, particularly the second electrode, may not be as significant and simplify design of the organic electronic device by only focusing on the low L_{background} for layers at a single elevation.

### EXAMPLES

The following specific examples are meant to illustrate and not limit the scope of the invention. Many of the thicknesses given in the examples below represent nominal thicknesses.

### Example 1

Example 1 illustrates that a high-contrast display can be obtained with a black first electrode in an OLED display without using a polarizer. It also demonstrates that the ambient light may be partially eliminated by tuning the optical length (the thicknesses of the polymer layers) of the OLEDs.

OLEDs with a black first electrode can be fabricated following a similar procedure described previously in this specification. Glass may be used as a substrate. In each of glass/(Cr and CrₓO_{y})/ITO, glass/(Ta and TaₓO_{y})/ITO, and glass/Si combinations, the (Cr and CrₓO_{y})/ITO, (Ta and TaₓO_{y})/ITO, or Si are used as the first electrode contact. The layers over the glass can be prepared by thermal evaporation, metalorganic chemical vapor deposition or plasma-enhanced chemical vapor deposition. The reflectivity or absorbance of the first electrode can be adjusted by changing the thickness(es) of Cr, Ta, or Si to achieve a light absorbance less than approximately 10%. A thin, transparent polyaniline layer can be spin-cast with thickness in a range of approximately 30-500 nm and be used as a hole-transport layer. A PPV derivative with an emission covering approximately 550-800 nm wavelength ranges can be used as the organic active layer. Its thickness may be approximately 70 nm. The total thickness of conducting and emitting layers are satisfied by the prior equation for reflectivity. Ba (3 nm)/Al (300 nm) can be used as the second electrode.

### Example 2

Example 2 demonstrates that high contrast can be obtained using a black second electrode in an OLED without using a polarizer. It also demonstrates that the ambient light can be partially eliminated by tuning the optical length (the thickness of the polymer layers) of the OLED. A contrast ratio of 50:1 may be obtained in an ITO/PANI/PPV/Ba (2 nm)/Al (10 nm)/Cr (200 nm) device.

OLEDs having black second electrodes may be fabricated following a similar procedure as described in Example 1 except as noted. The thickness of the organic active layer can be in a range of approximately 70-80 nm. The optical length of an OLED was varied by the thickness of transparent polyaniline layer. Ba/Al/Cr is used as the second electrode material with thicknesses of approximately 2 nm, 10 nm, and 200 nm, respectively.

Its performance is compared to a device with a traditional structure (no low-reflectivity layers). The contrast ratio of the OLED with the black second electrode (OLED layers include ITO/PANI/PPV/Ba (2 nm)/Al (10 nm)/Cr(200 nm)) is approximately 50:1. The OLED with a traditional metal second electrode (OLED layers include ITO/PANI/PPV/Ba (2 nm)/Al (400 nm)) has a CR of 15.

### Example 3

Example 3 demonstrates that the low-reflectivity layers can be used in radiation transparent OLEDs. A transparent OLED can include a structure of ITO/PANI/PPV/Ba (2 nm)/Al (10 nm)/Au (25 nm) or ITO/PANI/PPV/Ba (2 nm)/Al (10 nm)/ITO (200 nm).

Its performance is compared to a device having a relatively thicker aluminum second electrode (ITO/PANI/OAL/Ba (2 nm)/Al (500 nm), where “OAL” is an organic active layer. These devices are over 80% transparent from 400 to 700 nm using ITO as electrodes. These devices can be used for top emission devices made over an opaque substrate, such as a silicon chip or a thick metal layer. A contrast ratio of approximately 50:1 can be obtained in a device having the first composition. In comparison, the CR of an OLED with a thick Al second electrode can be approximately 15.

High contrast devices can be made with a black layer (conductive or non-conductive) over or underneath an ITO layer. For example, an OLED may have a structure of ITO/PANI/OAL/Ba (2 nm)/Al (10 nm)/ITO/carbon. The carbon layer may be used as a low-reflectivity layer for the second electrode (Ba (2 nm)/Al (10 nm)/ITO/carbon).

In the foregoing specification, the invention has been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of the invention.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims.

1. An organic electronic device comprising a first electrode, a second electrode, and an organic active layer, wherein:
the first electrode lies on an opposite side of the organic active layer compared to the second electrode; and
at least one layer selected from the first electrode, the second electrode, a hole-transport layer, an electron-transport layer, and the organic active layer is configured to achieve low L_{background}.

2. A process for forming an organic electronic device comprising the step of forming at least one layer selected from a first electrode, a second electrode, a hole-transport layer, an electron-transport layer, and an organic active layer, wherein:
the first electrode lies on an opposite side of the organic active layer compared to the second electrode; and
the at least one layer is designed to achieve low L_{background}.

3. The organic electronic device of claim 1 or the process of claim 2, wherein the at least one layer has a thickness in a range of d₁-d₂, wherein d₁ and d₂ are determined by:
2ηd₁ cos (θ)+φ=(m+¼)/λ (Equation 1)
2ηd₂ cos (θ)+φ=(m+¾)/λ (Equation 2)
wherein:
η is a refractive index of a material of the at least one layer at a specific wavelength (λ);
d₁ is a first thickness of the at least one layer;
d₂ is a second thickness of the at least one layer;
θ is an angle of incident radiation;
φ is a total phase change of radiation reflected by an ideal reflector at λ;
m is an integer; and
λ is the specific wavelength.

4. The organic electronic device of claim 1 or the process of claim 2, wherein an interfacial reflectivity is no greater than about 30 percent, wherein the interfacial reflectivity is determined by:
$$R = \frac{{I}_{reflected}}{{I}_{incident}} = {( \frac{{η}_{x} - {η}_{y}}{{η}_{x} + {η}_{y}} )}^{2} \qquad ( Equation 3 )$$
wherein:
ηₓ is a refractive index of the at least one layer; and
η_{y} is a refractive index of a different layer lying immediately adjacent to the at least one layer.

5. An organic electronic device comprising:
an organic active layer; and
a first electrode having a side opposite the organic active layer, wherein:
the first electrode comprises a first electrode layer lying at the side opposite the organic active layer; and
the first electrode layer is configured to achieve low L_{background}.

6. The organic electronic device of claim 5, further comprising a second electrode, wherein:
the organic active layer lies between the first electrode and the second electrode;
a second electrode has a side opposite the organic active layer; and
the second electrode comprises a second electrode layer lying at the side opposite the organic active layer; and
wherein the second electrode layer is configured to achieve low L_{background}.

7. A process for forming an organic electronic device comprising the steps of:
forming an organic active layer; and
forming a first electrode having a side opposite the organic active layer, wherein:
the first electrode comprises a first electrode layer lying at the side opposite the organic active layer; and
the first electrode layer is configured to achieve low L_{background}.

8. The process of claim 7, further comprising a step of forming a second electrode, wherein:
the organic active layer lies between the first electrode and the second electrode;
a second electrode has a side opposite the organic active layer; and
the second electrode comprises a second electrode layer lying at the side opposite the organic active layer; and
wherein the second electrode layer is configured to achieve low L_{background}.

9. The organic electronic device of claim 5 or the process of claim 7, wherein the first electrode layer has a thickness in a range of d₁-d₂, wherein d₁ and d₂ are determined by:
2ηd₁ cos (θ)+φ=(m+¼)/λ (Equation 1)
2ηd₂ cos (θ)+φ=(m+¾)/λ (Equation 2)
wherein:
η is a refractive index of a material of the first electrode layer at a specific wavelength (x);
d₁ is a first thickness of the first electrode layer;
d₂ is a second thickness of the first electrode layer;
θ is an angle of incident radiation;
φ is a total phase change of radiation reflected by an ideal reflector at λ;
m is an integer; and
λ is the specific wavelength.

10. The organic electronic device of claim 5 or the process of claim 7, wherein an interfacial reflectivity is no greater than about 30 percent, wherein the interfacial reflectivity is determined by:
$$R = \frac{{I}_{reflected}}{{I}_{incident}} = {( \frac{{η}_{x} - {η}_{y}}{{η}_{x} + {η}_{y}} )}^{2} \qquad ( Equation 3 )$$
wherein:
ηₓ is a refractive index of the first electrode layer; and
η_{y} is a refractive index of a material lying immediately adjacent to the first electrode layer.

11. The organic electronic device of claim 5 or the process of claim 7, wherein the first electrode layer comprises a metal selected from a transition metal and an elemental metal.

12. The organic electronic device or process of claim 11, wherein the metal is selected from a group consisting of Au, Cr, Si, and Ta.

13. The organic electronic device or process of claim 11, wherein the first electrode layer further comprises an oxide of the metal.

14. A process for designing an organic electronic device comprising the steps of:
determining a specific wavelength for reflected ambient radiation;
determining η at the specific wavelength for a first material; and
determining a range of thicknesses of a first layer of the first material, wherein the range of thicknesses is d₁-d₂, wherein d₁ and d₂ are determined by:
2ηd₁ cos (θ)+φ=(m+¼)/λ (Equation 1)
2ηd₂ cos (θ)+φ=(m+¾)/λ (Equation 2)
wherein:
η is a refractive index of the first material of the first layer at the specific wavelength (λ);
d₁ is a first thickness of the first layer;
d₂ is a second thickness of the first layer;
θ is an angle of incident radiation;
φ is a total phase change of radiation reflected by an ideal reflector at λ;
m is an integer; and
λ is the specific wavelength.

15. The process of claim 14, wherein the first layer is selected from a group consisting of an organic active layer, a hole-transport layer, and an electron-transport layer.

16. The process of claim 14, wherein:
the first layer is one of a plurality of layers of an electrode;
the electrode is designed to have a side that is opposite the organic active layer: and the first layer is designed to lie at the side of the electrode opposite an organic active layer.

17. The process of claim 14, wherein the process further comprises:
determining ηₓ at a specific wavelength for a second material of a second layer; and
determining η_{y} at the specific wavelength for a third material of a third layer immediately adjacent to the second layer, wherein an interfacial reflectivity at the second and third layers is no greater than about 30 percent, wherein the interfacial reflectivity is determined by:
$$R = \frac{{I}_{reflected}}{{I}_{incident}} = {( \frac{{η}_{x} - {η}_{y}}{{η}_{x} + {η}_{y}} )}^{2} \qquad ( Equation 3 )$$

18. A process for designing an organic electronic device comprising the steps of:
determining ηₓ at a specific wavelength for a first material of a first layer; and
determining η_{y} at the specific wavelength for a second material of a second layer immediately adjacent to the first layer, wherein an interfacial reflectivity at the first and second layers is no greater than about 30 percent, wherein the interfacial reflectivity is determined by:
$$R = \frac{{I}_{reflected}}{{I}_{incident}} = {( \frac{{η}_{x} - {η}_{y}}{{η}_{x} + {η}_{y}} )}^{2} \qquad ( Equation 3 )$$

19. The organic electronic device of claim 1 or 5 or the process of claim 2, 7, 14, or 18, wherein the organic electronic device is selected from the group of light-emitting displays, radiation sensitive devices, photoconductive cells, photoresistors, photoswitches, photodetectors, phototransistors, and phototubes.
